(19) United States
(12) Patent Application Publication
(10) Pub. No.: US 2004/0148630 A1
(43) Pub. Date: Jul. 29, 2004

(54) File searching method of data broadcasting system

(76) Inventor: Mi Ae Choi, Incheon-si (KR)

Correspondence Address: BIRCH STEWART KOLASCH & BIRCH, PO BOX 747, FALLS CHURCH, VA, 22040-0747, US

(21) Appl. No.: 10/759,307

(22) Filed: Jan. 20, 2004

(30) Foreign Application Priority Data
Jan. 20, 2003 (KR) 10-2003-0003737

(51) Int. Cl. H04N 5/445; G06F 3/00; G06F 17/30; G06F 7/00; G06F 13/00; G06F 17/00

(52) U.S. Cl. 725/53; 725/52; 707/1; 707/3; 707/100

(57) ABSTRACT

Disclosed is a file searching method of a data broadcasting system, the method including the steps of: confirming whether or not a control message of Download Server Initiate is updated, in response to a search request for a file object; and searching the search-requested file object from at a new root directory object, in case that the control message of Download Server Initiate is updated.

### BACKGROUND OF INVENTION

1. Field of the Invention

The present invention relates to a data broadcasting system, and more particularly, to a file searching method in which a search process can be remarkably reduced.

2. Description of the Related Art

Digital broadcasting is a common term of broadcastings transmitting digital data. America decided the transmission of a next generation television called an ATV (Advanced Television) as digital transmission. Further, In Europe, many projects are vigorously being advanced, such as HD DIVINE in Sweden, SPECTRE in England, DIAMOND in France and the like. The digital broadcasting, as a next generation manner associated with B-ISDN (Broadband Integrated Services Digital Network) or a computer network, has been vigorously studied in each of countries.

Generally, a stream transmitted in the digital broadcasting allows data information to be transmitted together with video/audio signals. Herein, data information is created on basis of HTML (hypertext markup language) of ATVEF (Advanced Television Enhancement Forum), XDML (extensible Document Markup Language) of DASE (Digital TV Application Software Environment) and Xlet of the DASE.

In the broadcasting of data information, a viewer can perform simple and convenient manipulation while watching on TV to obtain additional information relating with a program or to purchase goods. Further, the viewer can search concerned information such as weather, bonds, news and the like, and can perform banking business at home. Further, the viewer can directly take part in a live-broadcasted quiz program to obtain the goods depending on acquired points. An active part can be taken in such a manner that the viewer himself/herself provides a news article or reflects his/her opinion on broadcasting program.

The digital broadcasting can be divided into terrestrial broadcasting, satellite broadcasting, cable broadcasting and the like depending on its standard.

The terrestrial broadcasting, the satellite broadcasting, the cable broadcasting and the like have different broadcasting standards every country. For example, Korea adopts a North America ATSC (Advanced Television System Committee) manner for the terrestrial broadcasting, adopts a Europe DVB (Digital video Broadcasting) manner for the satellite broadcasting, and provisionally adopts an OCAP (Open Cable Applications Platform) for the cable broadcasting.

As the digital broadcasting specification adopted for the terrestrial broadcasting, there is an 8-VSB (Vestigial Side Band) of the ATSC (Advanced Television System Committee) specification that is currently developed in America, and it employs some of similar ones with a conventional analogous NTSC manner to provide an easy embodiment of a transceiver and an economical advantage.

As the digital broadcasting specification adopted for the satellite-broadcasting, there is the DVB (Digital Video Broadcasting) that is widely used in Europe. It is an international standard for allowing the digital broadcasting of audio and data.

The OCAP (Open Cable Applications Platform), a digital broadcasting specification adopted for the cable broadcasting, is a standard for manufacturing an application for a bi-directional service of the cable broadcasting, and can provide the broadcasting with a web-based service to support a more advanced bi-directional service.

Generally, a broadcasting station for supporting the data broadcasting of North America or Europe broadcasts a multimedia platform-specific application together with digital broadcasting programs.

Additionally, an appropriately constructed multimedia platform-specific set-top box can receive and locally execute the applications.

Applications are exemplified as an EPG (Electronic Program Guide), play-along games, telebanking, teleshopping, electronic papers and their similar information services.

The multimedia platform-specific applications are broadcasted in an object carousel. Herein, all application codes and data are circulated and broadcasted.

In current digital broadcasting systems, a transmitter typically transmits so many services (or channels) to, for example, a plurality of receivers installed at the set-top boxes. Such services can include an audio/video stream, a conversation application, and other kinds of data. A MPEG (Moving Picture Experts Group)-2 transmission stream is a complex of many services. The transmitter generally transmits several transmission streams to the set-top boxes.

In other words, an elementary stream is primarily packetized to create a PES (Packetized Elementary Stream), and the PES packet is again transformed to 188-bytes transport steam packet to be transmitted in a format of a series of transport streams.

At this time, PSI (Program specific Information) for e the programs transmitted through the transport steam is also inserted into the transport stream and transmitted.

The MPEG-2 transport stream is a complex of many services. The appropriately constructed set-top box can be tuned to a specific transport stream, and then can restore information from the transport stream.

As described above, the applications broadcast consecutive data sections that are periodically and sequentially repeated through the transport stream.

For example, as described above, the DVB has specific DSM-CC (Digital Storage Media-Command and Control) object carousels so as to broadcast the applications.

The objects of the DSM-CC object carousel are broadcasted to modules, and provide a file system comprised of a file and the directory objects in a file system manner.

FIG. 1 is a general architectural diagram illustrating an object carousel decoding process of a general transport stream.

As shown in FIG. 1, if a server (for example, broadcasting station) periodically transmits the transport stream, a client resolves from at the root directory so as to search a necessary file.

First, the server periodically transmits the MPEG-2 transport streams, and the client fragments the transport stream into sections. Herein, the sections include a DSI (Download Server Initiate) control message, a DII (Download Info Indication) control message, and a plurality of DDB (Download Data Block) data messages.

The DSI control message includes a module identifier, information relating to all of the object carousels (a time for which the object carousel is once rotated, a time-out value of object carousel rotation, and the like), root information and the like.

The DII control message is information corresponding to every module, and includes module information such as a size and version every module, a time-out value of the module, and the like.

The DDB data message includes the file objects located at the lower hierarchical architecture of the root directory.

Next, the directory object or the file objects are fragmented from the DDB data message in a unit of the module.

Accordingly, the DSI control message and the DII control message are referred in the file system to resolve the directory object or the file object included in each of the modules such that the desired file object can be searched.

As shown in FIG. 1, the object carousels are comprised of three layers. An upper layer can be comprised of the file and the directory objects, its underlying middle layer can be comprised of the modules, and its underlying layer can be comprised of individual data sections of a basic stream.

At this time, since respective directory objects acknowledge only its own lower directory information, resolution is always performed from at the root directory so as to search the file.

The directory objects are circularly transmitted together with respective modules totally transmitted and certain groups of the file and the directory objects formed by respective modules in the server. At the time of reception, the received file data and directory objects are arranged and stored under a certain grouping formula.

FIG. 2 is a conceptive view illustrating a general object search process.

As shown in FIG. 2, the root directory object (SGW) is designated to the “ServiceGatewayInfo( )” described in a user area (privateDataByte) of the DSI control message.

In other words, the IOR (Interoperable Object Reference) of the “ServiceGatewayInfo( )” not only includes an identifier corresponding to the carousel for searching the object, a module ID (identifier) including the object, and an identifier (objectkey) for specifying the object among one module, but also includes tap (assocTag) information for identifying the DII control message having module information including the object.

At this time, the DII control message includes a size of the module for each of one or more than modules, version information, and tap (assocTag) information for identifying the module.

Accordingly, in the file system, the DSI control message, the DII control message and a plurality of DDB sessions are fragmented from the transport stream of the DSM-CC manner, and the plurality of DDB sessions are fragmented into a plurality of modules.

At this time, the root directory object (SGW) designated to the IOR described in the user area (privateDataByte) of the DSI control message is searched.

Conventionally, the root directory object is always designated to the IOR such that the file object of the lower hierarchical architecture can be searched on basis of the root directory object.

In other words, in the IOR described in the user area of the DSI control message, the “serviceContextList_data_byte” is not yet specified and used.

As described above, the file system searches the root directory object in the DSI control message, and refers to the DII control message to sequentially search the file object or the lower directory object of the root directory object.

FIGS. 3A and 3B are views illustrating exemplary processes of searching the corresponding file object within the module in the conventional data broadcasting file system. FIG. 3A is a view illustrating an exemplary process of searching the corresponding file object within the module in the conventional data broadcasting file system, and FIG. 3B is an exemplary view illustrating a directory structure of a mine finder application.

Referring to FIG. 3A, a first module (Module1) includes the root directory object (com) and a first directory object (digisoft), a second module (Module2) includes a second directory object (Xlets), a third directory object (diginews) and the file list (file list) comprised of the plurality of file objects, and a third module (Module3) includes a fourth directory object (upload) and the file list (file list) comprised of the plurality of file objects.

The objects included in each of the modules of FIG. 3A in the hierarchical architecture are expressed as in FIG. 3B.

Herein, it is assumed that the corresponding file objects (digiNews.class, duff.jpg, story.class, dnxml.xml and the like) are searched for the following file request.

1) com/digisoft/xlets/diginews/digiNews.class

2) com/digisoft/xlets/diginews/duff.jpg

3) com/digisoft/xlets/diginews/story.class

4) com/digisoft/xlets/diginews/upload/dnxml.xml

In case that there is a request for the above file objects (digiNews.class., duff.jpg, story.class, dnxml.xml and the like), each of the directories is resolved on basis of the root directory object (com) in the file system.

First, in order to search the first file object (digiNews.class), the DSI control message having the root directory information designated is used to search the root directory object (com). At this time, the root directory object is included in the first module.

Accordingly, the DII control message having the first module information is used to search the first directory object (digisoft) being the lower directory of the root directory object (com).

If all directory paths included in the first module are searched, the DII control message having the second module information is used to respectively search the second directory object (Xlets) and the third directory object (diginews). At this time, since the file list (file list) comprised of the plurality of file objects exists at a lower of the third directory object, the search-targeted file object (digiNews.class) is searched in the file list. Herein, since a number of file objects exist in the file list, respective file objects are sequentially compared with one another so as to search the search-targeted file object (digiNews.class).

In other words, the file objects existing within the second module are compared until the desired file object (digiNews.class) is searched.

Additionally, the second file object (duff.jpg), the third file object (story.class) and the like undergo the above process such that the corresponding file objects are searched.

Accordingly, if 53 file objects are totally required for loading the mine finder application exemplified in FIG. 3B, the mine finder application has fifty file objects where the hierarchical architecture depth is 5, and has three file objects where the hierarchical architecture depth is 6.

Whenever one file object is searched, a resolution process is required to be performed at 268 times (=50 (the number of the file object)×5 (hierarchical architecture depth)+3 (the number of the file object)×6 (hierarchical architecture depth)) so as to search the 53 file objects.

Accordingly, in the above resolution process, a process for searching the corresponding file object should be duplicately performed at several times. As its architecture depth is deepened, the resolution process is more complicated and lengthened.

Therefore, the conventional stream transmission specification has a drawback in that the search is repetitively performed every time from the root directory object to the corresponding file so as to search the file, to thereby cause the overhead to be increased.

For example, in order to search the file object (digiNews.class) existing at a lower of the third directory object (diginews) and then search another file object (duff.jpg) as in an example of the mine finder application, the paths of the root directory object (con), the first directory object (digisoft) and the second directory object (xlets) should be again repetitively performed.

Further, even though the search-targeted files exist in the third module, the conventional stream transmission specification always repetitively requests all of the root directory object and the first and second modules such that the desired file object is searched in the third module including the desired file object.

Accordingly, the conventional stream transmission specification has a drawback in which the first and second modules of a front of the third module are repetitively searched so as to search the desired file object, and the repetitive search causes a total speed of the file search to be remarkably delayed and a work amount to be increased.

### SUMMARY OF THE INVENTION

Accordingly, the present invention is directed to a file searching method of a data broadcasting system that substantially obviates one or more problems due to limitations and disadvantages of the related art.

An object of the present invention is to provide a file searching method of a data broadcasting system in which an overhead for searching a desired file object can be reduced and a searching speed can be improved in an object carousel that is defined to support a hierarchical architecture of data in data broadcasting.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a file searching method of a data broadcasting system, the method including the steps of: confirming whether or not a control message of Download Server Initiate is updated, in response to a search request for a file object; and searching the search-requested file object from at a new root directory object, in case that the control message of Download Server Initiate is updated.

Herein, an absolute path can be not written and a basic root directory object can be designated in the non-updated control message of Download Server Initiate.

Also, the absolute path can be written and the new root directory object can be designated in the updated control message of Download Server Initiate.

It is desirable that the new root directory object is a directory object of a next hierarchical architecture of the written absolute path.

In another aspect of the present invention, there is provided a file searching method of a data broadcasting system, the method including the steps of: confirming whether or not an absolute path exists in a control message of Download Server Initiate, in response to a search request for a file object; and searching the search-requested file object from at a new directory object designated correspondingly to the absolute path, in case that the absolute path exists.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a general architectural diagram illustrating an object carousel decoding process of a general transport stream;

FIG. 2 is a conceptive view illustrating a general object search process;

FIGS. 3A and 3B are views illustrating exemplary processes of searching a corresponding file object within a module in a conventional data broadcasting file system;

FIGS. 4A and 4B are conceptive views illustrating object search processes' in a data broadcasting system according to the present invention; and

FIG. 5 is a flow chart illustrating a method for searching an object in a data broadcasting system according to the present invention.

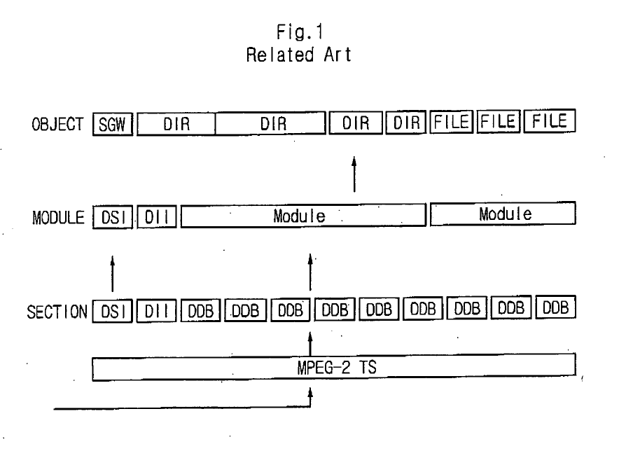

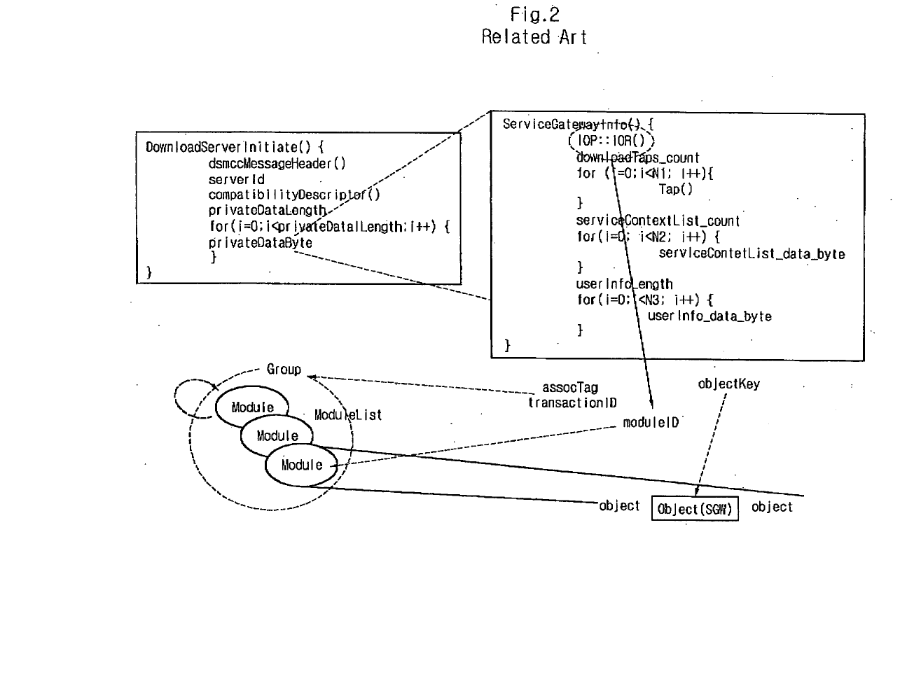

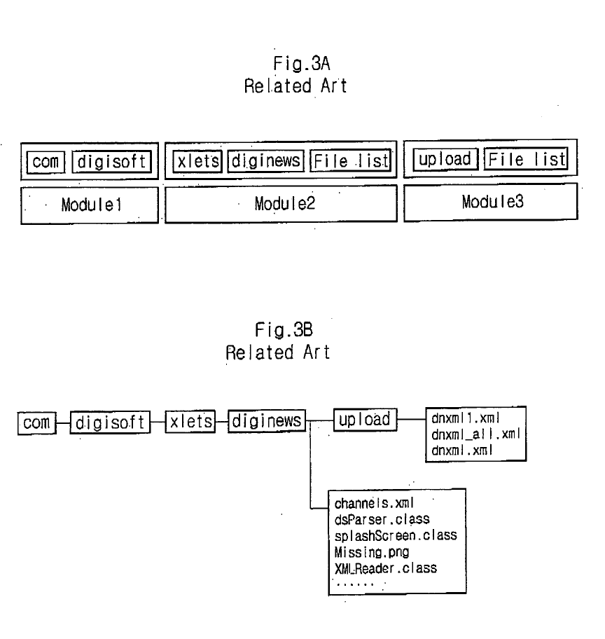

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

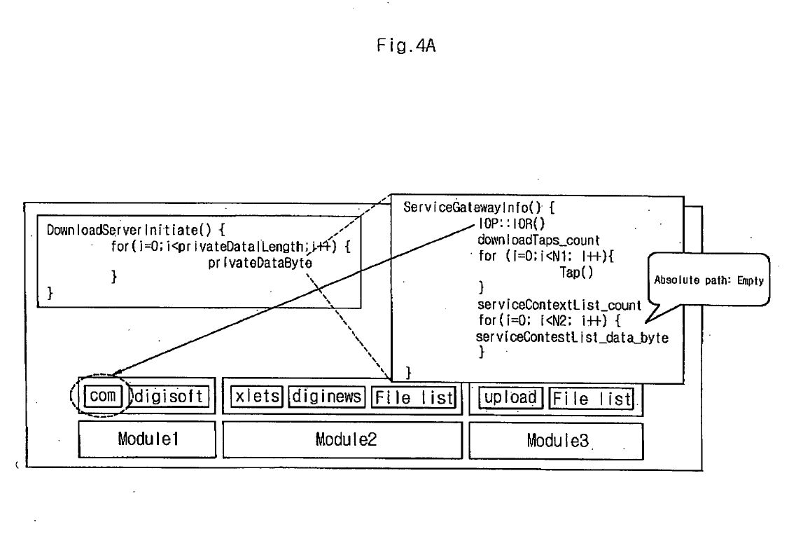

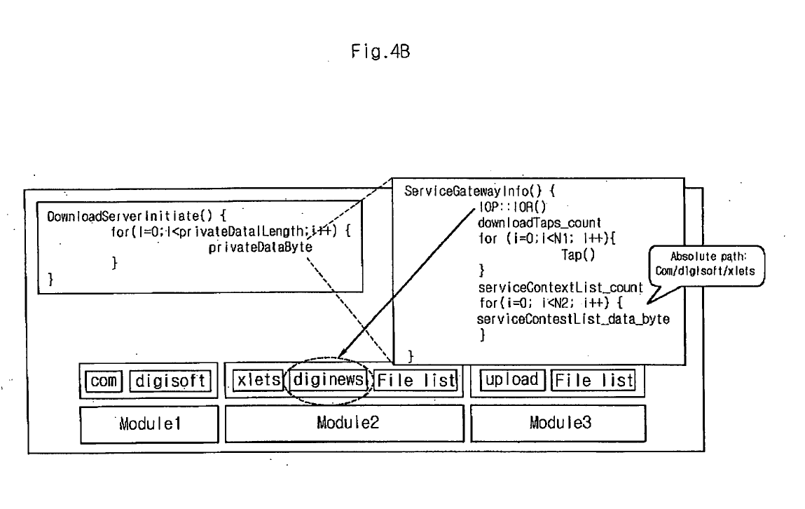

FIGS. 4A and 4B are conceptive views illustrating object search processes in a data broadcasting system according to the present invention. FIG. 4A represents a DSI control message having a basic root directory designated, and FIG. 4B represents a DSI control message having a search-targeted root directory designated.

In the present invention, a dynamic search is controlled using a “serviceContext_data_byte” that is not defined in an Interoperable Object Reference (IOR) of a DSI control message.

Referring to FIG. 4A, the basic root directory object is designated to a “ServiceGatewayInfo( )” of the DSI control message fragmented from an initial transmitted DSM-CC transport stream, and an absolute path is not written and is empty in the “serviceContext_data_byte.” Herein, the basic root directory object means a directory object most initially located in a hierarchical architecture for searching any file object. Generally, a desired file object is searched via a corresponding path on basis of the basic root directory object.

Further, the absolute path represents a path for the directory object existing in a whole hierarchical architecture of the basic root directory object designated to the “ServiceGatewayInfo( ).” Accordingly, in case that the absolute path is written, a search process is not performed at the directory objects corresponding to the corresponding absolute path, and straightly, the search process is performed from at the designated basic root directory object.

As in FIG. 4A, the absolute path is not written in the initially transmitted DSI control message such that the search process is performed from at the designated basic root directory.

In other words, the basic root directory object (com) designated to the “ServiceGateInfo( )” of the DSI control message is searched, and then a lower directory object (digisoft/xlets/diginews) corresponding to a hierarchical architecture depth consumed from at the basic root directory object is searched while the desired file object (digiNews.class) is finally searched.

At this time, while the desired file object is searched, the absolute path and a new root directory object are obtained.

The obtained absolute path and new root directory object is used to update the DSI control message. That is, in the file system, the new root directory object (for example, diginews) is designated to the “ServiceGatewayinfo( )” of the DSI control message, and the absolute path can be written in the “serviceContext_data_byte for updating. At this time, if the DSI control message is updated, corresponding version information is also updated together such that it can be later distinguished whether or not the DSI control message is updated.

The above updated DSI control message is illustrated in FIG. 4B.

As shown in FIG. 4B, in the updated DST control message, the new root directory object (for example, diginews) is designated to the “ServiceGateInfo( )”, and the absolute path (com/digisoft/xlets) is written in the “serviceContext_data_byte.”

In the file system, the search is performed using the updated DSI control message. That is, it is confirmed whether or not the absolute path is written in the updated DSI control message. At this time, in case that the absolute path (com/digisoft/xlets) is written in the “serviceContext_data_byte”, the search process is performed from at the new root directory object (diginews) being a next hierarchical architecture of the absolute path.

Accordingly, the search is not initiated from at the basic root directory object (com) and straightly, the search is performed from at the new root directory object (diginews) designated as the next hierarchical architecture of the absolute path (com/digisoft/xlets). Accordingly, the process of repetitively searching a duplicated directory object is omitted such that the overhead can be reduced and an entire search speed can be remarkably improved.

In the file system, the basic root directory object (com) of the initially transmitted DSI control message is acknowledged as an initial root directory object for searching the desired file object (digiNews.class), and the search is initiated from at the basic root directory object. At this time, as the absolute path and the new root directory object obtained from the process of searching the desired file object are used to update the DSI control message, in case that other file objects than the initially searched file object are searched, the new root directory object is acknowledged as the initial root directory such that the search is initiated from at the new root directory object. Accordingly, the search does not need to be performed as much as the absolute path such that as much as that, the overhead is reduced and further the search speed is improved.

For example, it is assumed that 53 files totally need to load the aforementioned mine finder application. At this time, the mine finder application has 50 file objects where the hierarchical architecture depth is 5, and has 3 files where the hierarchical architecture depth is 6.

Since the absolute path is not written and the basic root directory object is designated in the initially transmitted DSI control message, the search is initiated from at the basic root directory object to search the initial file object. Herein, it is assumed that the absolute path and the new root directory object obtained from the process of searching the initial file object are used to update the DSI control message.

At this time, the mine finder application needs to perform the search process at 60 times.

That is, 60 times=1 (initial file object)×5 (5-stepped hierarchical architecture depth from basic root directory object)+49 (49 remaining file objects other than the initial file object among 50 file objects having the same path)×1 (1-stepped hierarchical architecture depth from new root directory and absolute path including duplicated directory)+3 (the number of file object)×2 (2-stepped hierarchical architecture depth from new root directory object).

Accordingly, the present invention has an effect in that the desired file object can be easily searched, the overhead is reduced, the search speed is improved and work amount is remarkably reduced, by using the absolute path and the new root directory object.

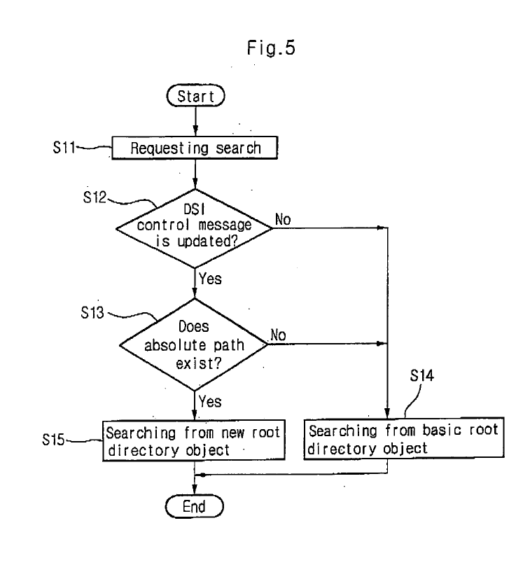

FIG. 5 is a flow chart illustrating a method for searching the object in the data broadcasting system according to the present invention.

First of all, if the search for the file object is requested (S11), the version information is used to confirm whether or not the DSI control message is updated (S12).

In case that the DSI control message is not updated, the search process is performed on basis of the basic root directory object designated to the “ServiceGatewayInfo( )” (S14).

In case that the DSI control message is updated, it is confirmed from the “serviceContext_data_byte” whether or not there is the absolute path (S13).

In this case, the absolute path is written in the ¢serviceContext_data_byte” of the updated DSI control message, and the new root directory object is designated to the “ServiceGatewayInfo( ).

In case that the absolute path does not exist in the DSI control message, it is moved to the step (S14) to perform the search process on basis of the basic root directory object.

In case that the absolute path exists in the DSI control message, the search process is performed on basis of the new root directory object (S15).

Herein, it is desirable that the new root directory object is the directory object of the next hierarchical architecture of the absolute path.

For example, when the path for the desired file object is a “com/digisoft/xlets/diginews”, in case that the absolute path is written as the “com/digitsoft/xlets” in the “serviceContext_data_byte”, the “diginews” being the next hierarchical architecture of the absolute path is designated as the new root directory object.

At this time, it is desirable that the absolute path is comprised of at least two paths of the directory objects.

When any application is transmitted as the transport stream, the absolute path is not written in the DSI control message and at the same time, the basic root directory object is designated.

In this case, if the search for the file object is requested, the search process is performed from at the basic root directory object that is designated due to non-existence of the absolute path.

As described above, if the desired file object is searched from at the basic root directory object, the absolute path and the new root directory object are obtained in the process of searching the desired file object, and the obtained absolute path and new root directory object is used to update the DSI control message.

Accordingly, in the updated DSI control message, the absolute path is written and at the same time, the new root directory object is designated.

At this time, in case that the search for the file object is again requested, since the absolute path is written in the updated DSI control message, the search is performed from at the new root directory object being the next lower hierarchical architecture of the absolute path.

By operating as above, in any application, the basic root directory object is initially used to search the desired file object, and when other file objects are searched, the absolute path and the new root directory object can be used to straightly search other file objects.

Accordingly, whenever other file objects are searched, the search is omitted as much as the absolute path and is performed such that the file object can be more easily searched, and the overhead is reduced, and the search speed is remarkably improved, and the work amount can be greatly reduced.

The present invention has an effect in which the absolute path is used to omit the repeated search process such that a memory capacity can be economized, the overhead is reduced, the search speed is greatly improved, and the duplicated work amount is reduced to effectively utilize the object carousel.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A file searching method of a data broadcasting system, the method comprising the steps of:
confirming whether or not a control message of Download Server Initiate is updated, in response to a search request for a file object; and
searching the search-requested file object from at a new root directory object, in case that the control message of Download Server Initiate is updated.

2. The file searching method according to claim 1, wherein it is confirmed from version information whether or not the control message of Download Server Initiate is updated.

3. The file searching method according to claim 1, wherein an absolute path is not written and a basic root directory object is designated in the non-updated control message of Download Server Initiate.

4. The file searching method according to claim 3, wherein the basic root directory object is a directory object located most initially in a hierarchical architecture for searching a file object.

5. The file searching method according to claim 1, wherein the absolute path is written and the new root directory object is designated in the updated control message of Download Server Initiate.

6. The file searching method according to claim 5, wherein the new root directory object is a directory object of a next hierarchical architecture of the written absolute path.

7. The file searching method according to claim 5, wherein the written absolute path is comprised of at least two paths of the directory objects.

8. The file searching method according to claim 1, wherein the control message of Download Server Initiate is updated in case that a certain file object is searched at least one time.

9. The file searching method according to claim 8, wherein the absolute path and the new root directory object are obtained from the step of searching the certain file object at least one time.

10. A file searching method of a data broadcasting system, the method comprising the steps of:
confirming whether or not an absolute path exists in a control message of Download Server Initiate, in response to a search request for a file object; and
searching the search-requested file object from at a new directory object designated correspondingly to the absolute path, in case that the absolute path exists.

11. The file searching method according to claim 10, wherein the new root directory object is a directory object of a next hierarchical architecture of the existing absolute path.

12. The file searching method according to claim 10, wherein the existing absolute path is comprised of at least two paths of the directory objects.

13. The file searching method according to claim 10, wherein the existing absolute path is created in case that a certain file object is searched at least one time, to be written in the control message of Download Server Initiate.
